(19) United States
(12) Patent Application Publication
(10) Pub. No.: US 2023/0329192 A1
(43) Pub. Date: Oct. 19, 2023

(54) MULTI-GEAR ADJUSTABLE PET FOOD DISPENSING DEVICE

(71) Applicant: Kadtc Pet Supplies INC, Los Angeles, CA (US)

(72) Inventor: CHANGLI WU, Linyi (CN)

(21) Appl. No.: 18/109,038

(22) Filed: Feb. 13, 2023

(30) Foreign Application Priority Data
Apr. 15, 2022 (CN) 202220888586.X

(51) Int. Cl. A01K 5/01

(52) U.S. Cl. CPC A01K 5/0114

(57) ABSTRACT

The application discloses a pet food dispensing device with adjustable feeding speed, comprising a base and a food storage part, wherein the food storage part is arranged above the base, and an adjustment rotating dish is also arranged between the base and the food storage part, the adjustment rotating dish is provided with a plurality of food dispensing holes with different sizes, and food dispensing channels are arranged on the base; by rotating the adjustment rotating dish, the food dispensing holes with different sizes can be aligned with the food dispensing channel or disconnected from the food dispensing channel according to the needs, which has the advantage of being able to adjust the feeding speed of pet food according to needs.

### TECHNICAL FIELD

The present application the field of pet products, in particular to a pet food dispensing device with adjustable feeding speed.

### BACKGROUND

As people's living standards are getting higher and higher, more and more families keep pets. In the prior art, a tumbler-shaped pet food dispensing device has been developed, which comprises a base and a storage part. The base is provided with a counterweight, and food is placed in the storage part, and the food in the storage part is dispensed to the outside through the food dispensing channel. In addition to the function of playing for pets, the product also provides the function of feeding.

The disadvantage of the prior art is that the food dispensing device does not have the function of adjusting the speed of pet food feeding, and cannot adapt to the food feeding for pets with different body sizes.

### SUMMARY OF THE APPLICATION

The technical problem to be solved in the present application is to provide a pet food dispensing device with adjustable feeding speed.

The technical solution provided by the present application to solve the above-mentioned technical problems is: A pet food dispensing device with adjustable feeding speed, comprising a base and a food storage part, wherein the food storage part is arranged above the base, and an adjustment rotating dish is also arranged between the base and the food storage part, the adjustment rotating dish is provided with a plurality of food dispensing holes with different sizes, and food dispensing channels are arranged on the base; by rotating the adjustment rotating dish, the food dispensing holes with different sizes can be aligned with the food dispensing channel or disconnected from the food dispensing channel according to the needs.

The further preferred solution of the present application is: the pet food dispensing device with adjustable feeding speed is provided with three types of food dispensing holes, namely small food dispensing holes, medium food dispensing holes and large food dispensing holes, different sizes of food dispensing holes and food dispensing channels are connected to realize a small gear, a middle gear and a large gear.

The further preferred solution of the present application is: the pet food dispensing device with adjustable feeding speed is provided with two small food dispensing holes, two medium food dispensing holes, and two large food dispensing holes and two food dispensing channels.

The further preferred solution of the present application is: the adjustment rotating dish is provided with a plurality of baffle plates.

The further preferred solution of the present application is: the plurality of baffle plates are distributed on the surface of the adjusting rotating dish in a divergent shape with the center of the adjusting rotating dish as the center.

The further preferred solution of the present application is: a single food dispensing hole or a closed area is arranged between two adjacent baffle plates.

The further preferred solution of the present application is: the base is provided with a counterweight, and a lower surface of the base is semi-spherical.

The further preferred solution of the present application is: a plurality of hooks are arranged on the upper edge of the base, and each hook is bent to form a positioning groove, and the edge of the adjustment rotating dish falls into the positioning groove.

The further preferred solution of the present application is: a detachable cover is provided on the food storage part.

The further preferred solution of the present application is: the food dispensing channels are arranged vertically.

In the present application, a an adjustment rotation dish is added between the base and the food storage part, and food dispensing holes with different sizes are arranged on the adjustment rotating dish. When it is necessary to adjust the food feeding speed, it is only necessary to align the dispensing hole with the corresponding size with the dispensing channel to realize the control of the food feeding speed.

### BRIEF DESCRIPTION OF THE DRAWINGS

FIG. 1 is a perspective view of the present application;

FIG. 2 is a top view of the base and the adjustment rotating dish of the present application;

FIG. 3 is an exploded view of the base and the adjustment rotating dish of the present application;

FIG. 4 is an enlarged view at A in FIG. 3;

FIG. 5 is a sectional view of the present application.

### DETAILED DESCRIPTION

The present application will be described in further detail below in conjunction with the accompanying drawings and embodiments.

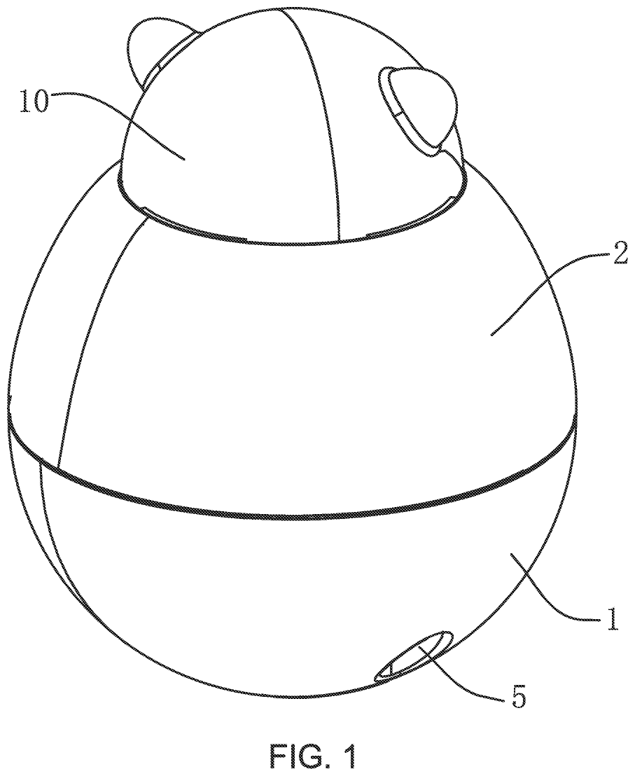

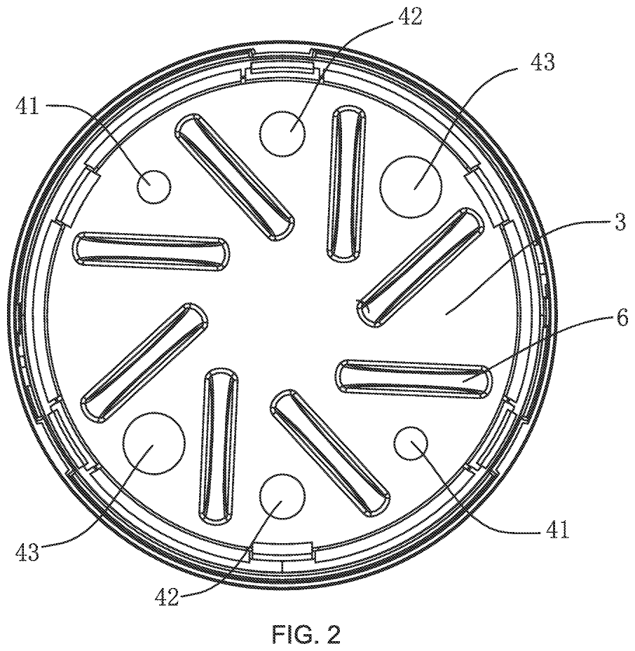

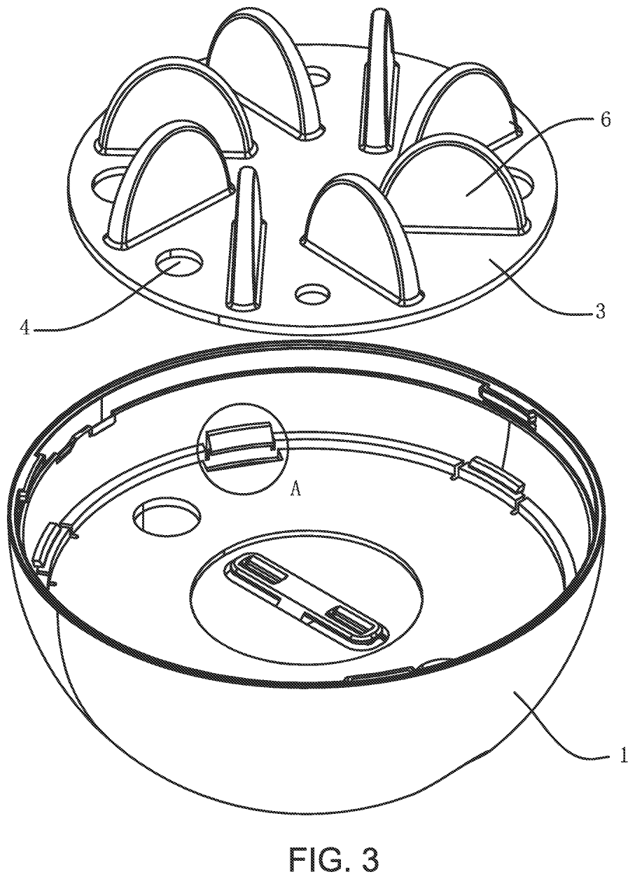

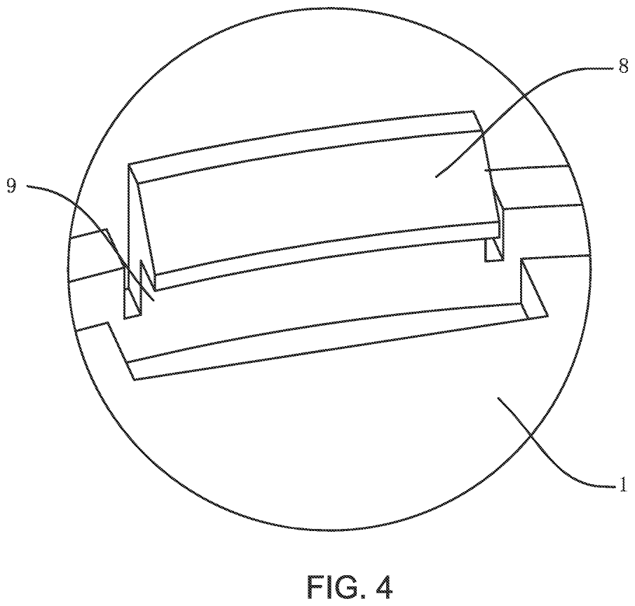

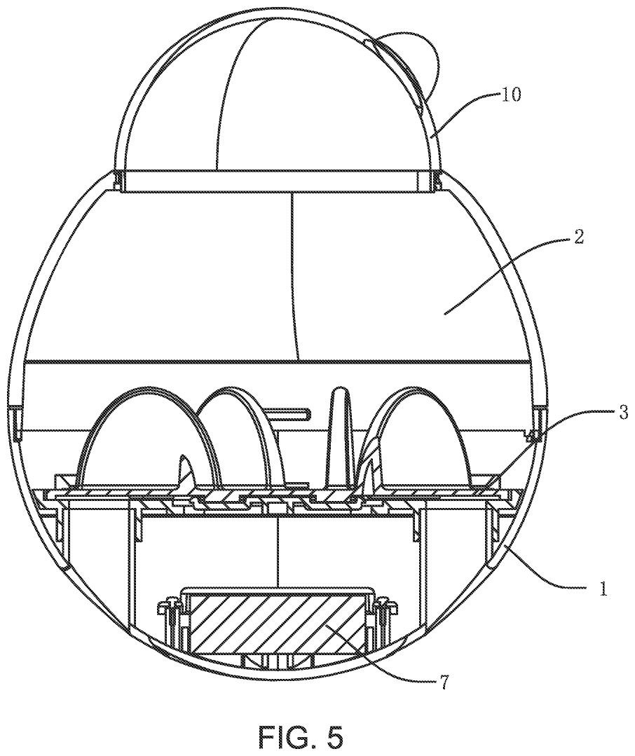

As shown in FIGS. 1 to 5, a pet food dispensing device with adjustable feeding speed comprises a base 1 and a food storage part 2, wherein the food storage part 2 is arranged above the base 1, the food storage part 2 is used to store food for pets. An adjustment rotating dish 3 is also arranged between the base 1 and the food storage part 2, the adjustment rotating dish 3 is provided with a plurality of food dispensing holes 4 with different sizes, and food dispensing channels 5 are arranged on the base 1; by rotating the adjustment rotating dish 3, the food dispensing holes 4 with different sizes can be aligned with the food dispensing channel 5 or disconnected from the food dispensing channel 5 according to the needs. The present application comprises two basic states, the first is use state, in this state, the food dispensing hole 4 is aligned with the food dispensing channel 5, and the food can fall from the food dispensing device; the second is non-use state, in this state, the food dispensing hole 4 is not aligned with the food dispensing channel 5, and the food cannot fall from the food dispensing device.

The pet food dispensing device with adjustable feeding speed is provided with three types of food dispensing holes 4, namely small food dispensing holes 41, medium food dispensing holes 42 and large food dispensing holes 43, different sizes of food dispensing holes 4 and food dispensing channels 5 are connected to realize a small gear, a middle gear and a large gear. In the small gear, the small food dispensing holes 41 are aligned with the food dispensing channels 5, and the food feeding speed is the slowest at this time, and dog food with small size can be used. When in the middle gear, the middle food dispensing holes 42 are aligned with the food dispensing channels 5. At this time, the food feeding speed is average, and dog food with slightly larger size can be used. When in the large gear, the large food dispensing holes 43 are aligned with the food dispensing channels 5, and the food feeding speed is the fastest at this time, and large-size freeze-dried food can be used. There are two small food dispensing holes 41, two middle food dispensing holes 42, two large food dispensing holes 43, and two food dispensing channels 5. Two dispensing holes 4 make the scattering of food more even.

The adjustment rotating dish 3 is provided with a plurality of baffle plates 6. The baffle plate 6 is used for the operator to manually adjust the rotation of the adjustment rotating dish 3 on the one hand, and also has the function of blocking the food circulation on the other hand. Pets need to fiddle with the food dispensing device many times to drop the food to the outside, which enhances the playability of the food dispensing device for pets. The plurality of baffle plates 6 are distributed on the surface of the adjusting rotating dish 3 in a divergent shape with the center of the adjusting rotating dish 3 as the center. The baffle plate 6 divides the foods in different regions, so that foods are more evenly distributed and less likely to aggregate together. A single food dispensing hole 4 or a closed area is arranged between two adjacent baffle plates 6 for enhancing the blocking effect of the baffle plates. The base 1 is provided with a counterweight 7, and the lower surface of the base 1 is semi-spherical, which acts as a tumbler and increases the interest of the food dispensing device. A plurality of hooks 8 are arranged on the upper edge of the base 1, and each hook 8 is bent to form a positioning groove 9, and the edge of the adjustment rotating dish 3 falls into the positioning groove 9. The adjustment rotating dish 3 is circular, and the adjustment rotating dish 3 can rotate above the base 1 under the limitation of a plurality of positioning grooves 9. The food storage part 2 is provided with a detachable cover 10, which is convenient for replenishment and replacement of food. The food dispensing channels 5 are arranged vertically, and the food dispensing speed is fast and unobstructed.

The above is a detailed introduction of a pet food dispensing device with adjustable feeding speed provided by the present application. The present application uses specific examples to illustrate the principles and implementation methods of the present application, and the descriptions of the above embodiments are only used to help understand the present application and its core ideas. It should be pointed out that those skilled in the art can make some improvements and modifications to the present application without departing from the principles of the present application, and these improvements and modifications also fall within the protection scope of the claims of the present application.

1. A pet food dispensing device with adjustable feeding speed, comprising a base and a food storage part, wherein the food storage part is arranged above the base, and an adjustment rotating dish is also arranged between the base and the food storage part, the adjustment rotating dish is provided with a plurality of food dispensing holes with different sizes, and food dispensing channels are arranged on the base; by rotating the adjustment rotating dish, the food dispensing holes with different sizes can be aligned with the food dispensing channel or disconnected from the food dispensing channel.

2. The pet food dispensing device with adjustable feeding speed according to claim 1, wherein the multi-gear adjustable pet food dispensing device is provided with three types of food dispensing holes, namely small food dispensing holes, medium food dispensing holes and large food dispensing holes, different sizes of food dispensing holes and food dispensing channels are connected to realize a small gear, a middle gear and a large gear.

3. The pet food dispensing device with adjustable feeding speed according to claim 2, wherein the multi-gear adjustable pet food dispensing device is provided with two small food dispensing holes, two medium food dispensing holes, and two large food dispensing holes and two food dispensing channels.

4. The pet food dispensing device with adjustable feeding speed according to claim 1, wherein the adjustment rotating dish is provided with a plurality of baffle plates.

5. The pet food dispensing device with adjustable feeding speed according to claim 4, wherein the plurality of baffle plates are distributed on the surface of the adjusting rotating dish in a divergent shape with a center of the adjusting rotating dish as the center.

6. The pet food dispensing device with adjustable feeding speed according to claim 5, wherein a single food dispensing hole or a closed area is arranged between two adjacent baffle plates.

7. The pet food dispensing device with adjustable feeding sp according to claim 1, wherein the base is provided with a counterweight, and a lower surface of the base is semi-spherical.

8. The pet food dispensing device with adjustable feeding speed according to claim 1, wherein a plurality of hooks are arranged on an upper edge of the base, and each hook is bent to form a positioning groove, and the edge of the adjustment rotating dish falls into the positioning groove.

9. The pet food dispensing device with adjustable feeding speed according to claim 1, wherein a detachable cover is provided on the food storage part.

10. The pet food dispensing device with adjustable feeding speed according to claim 1, wherein the food dispensing channels are arranged vertically.
